(19) United States
(12) Patent Application Publication
(10) Pub. No.: US 2002/0180131 A1
(43) Pub. Date: Dec. 5, 2002

(54) Thrust plate assembly

(75) Inventors: Hartmut Bach, Schweinfurt (DE); Cora Carlson, Dittelbrunn (DE); Matthias Dorfler, Schweinfurt (DE); Gunther Esly, Wasserlosen (DE); Reinhard Feldhaus, Niederwerrn (DE); Ingrid Hoffelner, Knetzgau (DE); Christoph Kleuker, Springe (DE); Paul Kraus, Niederwerrn (DE); Andreas Orlamunder, Schweinfurt (DE); Bernd Peinemann, Niederwerrn (DE); Michael Peterseim, Oberdorla (DE); Gerhard Roll, Eisenheim (DE); Ralf Till, Euerbach (DE); Sebastian Vogt, Bad Neustadt (DE); Andreas Dau, Wurzburg (DE)

Correspondence Address: Thomas C. Pontani, Esq., Cohen, Pantani, Lieberman & Pavane, Suite 1210, 551 Fifth Avenue, New York, NY, 10176, US

(73) Assignee: ZF Sachs AG

(21) Appl. No.: 10/160,386

(22) Filed: May 30, 2002

(30) Foreign Application Priority Data
Jun. 1, 2001 (DE) 101 26 776.2

(51) Int. Cl. F16F 1/18

(52) U.S. Cl. 267/158

(57) ABSTRACT

A pressure plate is held by at least one leaf spring arrangement so as to be movable axially with respect to the housing. The at least one leaf spring arrangement cooperates in a first coupling area thereof with the pressure plate for transmission of force and cooperates in a second coupling area thereof with the housing for transmission of force. For this purpose, the at least one leaf spring arrangement cooperates in one of first coupling area and second coupling area with the component group of housing and pressure plate cooperating with this coupling area for transmission of force in order to transmit force in only one circumferential direction.

### BACKGROUND OF THE INVENTION

1. Field of the Invention

The present invention is directed to a thrust plate assembly for a friction clutch, comprising a housing and a pressure plate which is held by at least one leaf spring arrangement so as to be movable axially with respect to the housing, and the at least one leaf spring arrangement cooperates in a first coupling area thereof with the pressure plate for transmission of force and cooperates in a second coupling area thereof with the housing for transmission of force.

2. Description of the Related Art

Connecting a pressure plate to a housing arrangement by means of tangential leaf springs is a variant that has long been known in the area of friction clutches by which a pressure plate can be connected with the housing arrangement so as to be essentially fixed with respect to rotation and displaceable axially relative to this housing arrangement. In known friction clutches, the tangential leaf springs extend in circumferential direction proceeding from the respective connection areas of the pressure plate to an associated connection area of the housing arrangement. Since all tangential leaf springs are identically oriented in circumferential direction, a configuration results such that in pull operation, for example, the tangential leaf springs are also tensile loaded, while in push operation, that is, for example, when there is an engine braking effect, the tangential leaf springs are compression loaded. While this compression loading is not a problem in conventional arrangements in which these tangential leaf springs are constructed essentially flat, i.e., without curvature, problems result in arrangements which are constructed for generating a self-energizing or self-reinforcing pressing effect. In these thrust plate assemblies with self-reinforcing pressing effect, the tangential leaf springs are sharply curved in axial direction between the two areas of arrangement at the pressure plate on the one hand and at the housing on the other hand. In pull operation, these tangential leaf springs which are then also tensile loaded tend to stretch, as a result of which, due to the axial offset of the two arrangement areas, the pressure plate is pressed with greater force against the friction linings of a clutch disk. However, in push operation, these sharply curved structural component parts can very easily be deformed and compressed which can even result in breakage of the same.

### SUMMARY OF THE INVENTION

It is the object of the present invention to provide a thrust pate assembly with self-reinforcing pressing effect which provides for relieving compressive loading of the at least one leaf spring arrangement.

According to the present invention, this object is met by a thrust plate assembly for a friction clutch, comprising a housing and a pressure plate which is held by at least one leaf spring arrangement so as to be movable axially with respect to the housing, wherein the at least one leaf spring arrangement cooperates in a first coupling area thereof with the pressure plate for transmission of force and cooperates in a second coupling area thereof with the housing for transmission of force.

According to the invention, it is further provided that the at least one leaf spring arrangement cooperates in a coupling area of first coupling area and second coupling area with the component group of housing and pressure plate cooperating with this coupling area for transmission of force in order to transmit force in only one circumferential direction.

According to the present invention, it is also ensured that a force can be transmitted by the at least one leaf spring arrangement only when acted upon in one direction, that is, for example, in pull operation. Since there is no interaction of the at least one leaf spring arrangement with respect to force in the other direction, no overloading and, therefore, also no damage can be caused.

It can be provided, for example, that the at least one leaf spring arrangement is secured in the other coupling area of first coupling area and second coupling area to the component group of pressure plate and housing cooperating with this other coupling area for transmission of force, that a first contact area is provided at the component group cooperating with the one coupling area for transmission of force, wherein the at least one leaf spring arrangement can be supported by its coupling area at this first contact area when the pressure plate rotates relative to the housing in a first relative rotation direction, and a second contact area is provided, wherein the component group associated with the other coupling area can be supported at this second contact area when the pressure plate rotates relative to the housing in a second relative rotation direction opposite to the first relative rotation direction without the intermediary of the at least one leaf spring arrangement. Thus, one of the contact areas will be active depending on the direction in which torque is to be transmitted, i.e., depending on whether pull operation or push operation is in effect, wherein force is transmitted between the housing and the pressure plate by the at least one leaf spring arrangement when the first contact area is active, that is, in the pull state, while force is transmitted between the housing and the pressure plate when the second contact area is active, that is, in push operation, for example, through direct contact, but in every case without the intermediary of or participation of the at least one leaf spring arrangement.

The effectiveness of the coupling area of the at least one leaf spring arrangement on only one side with respect to transmission of force can be realized by providing a cutout extending approximately in circumferential direction at the component group cooperating with the one coupling area for transmitting force, the one coupling area of the at least one leaf spring arrangement being moveable therein, and in that a wall defining the cutout forms the first contact area. In order to make use of the self-reinforcing effect in this arrangement with greater assurance by means of the tendency of a leaf spring arrangement of this type to stretch, it is suggested that the least one leaf spring arrangement can be supported in its coupling area at the first contact area substantially in axial direction in a positive engagement. This can be achieved, for example, by providing a toothing arrangement at the one coupling area and/or at the first contact area.

The torque transmission coupling between the housing arrangement and the pressure plate arrangement can be achieved in a simple manner without the contribution of the at least one leaf spring arrangement in that the second contact area cooperates with the component group cooperating with the other coupling area for force transmission in a support area in which the at least one leaf spring arrangement is secured by its other coupling area.

In a particularly preferred embodiment form which, in particular, has a working characteristic that is essentially unimpaired by wear, the at least one leaf spring arrangement can have two leaf spring elements which are arranged at an axial distance from one another at least in an area between the first coupling area and the second coupling area and the one coupling area is provided at a portion bridging the two leaf spring elements.

Further, the first coupling area and the second coupling area are preferably offset axially in relation to one another.

The present invention is further directed to a friction clutch comprising a thrust plate assembly according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal section through a friction clutch;

FIG. 2 is a schematic axial view of the pressure plate of the friction clutch shown in FIG. 1, which pressure plate is coupled with a housing arrangement;

FIG. 3 shows the principle of operation of a clutch with self-reinforcing action;

FIG. 4 is a detailed view showing a first construction, according to the invention, of the torque transmission coupling between the pressure plate and the housing;

FIGS. 5-8 show an alternate construction of the torque transmission coupling in different operating states;

FIG. 9 shows a modification of the construction variants shown in FIGS. 5 to 8;

FIG. 10 shows another modification of the construction shown in FIGS. 5 to 8; and

FIG. 11 is a sectional view of the construction variant shown in FIG. 10 along a line XI-XI in FIG. 10.

### DETAILED DESCRIPTION OF THE PRESENTLY PREFERRED EMBODIMENTS

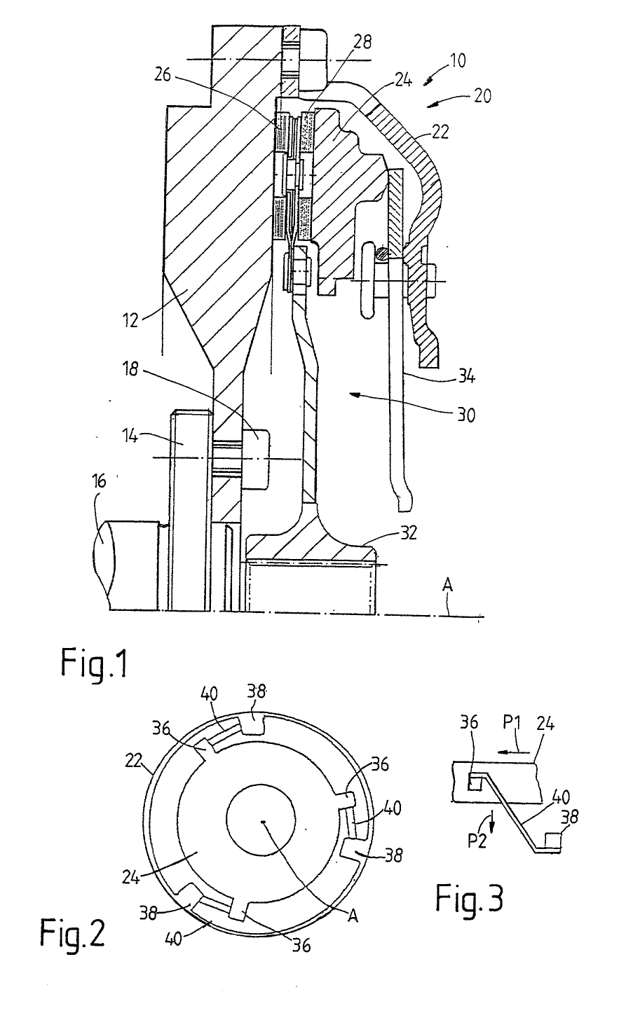

The basic construction of a friction clutch 10 in which the inventive principles are or can be realized is shown in FIGS. 1 and 2. The friction clutch 10 comprises a flywheel 12 which can be constructed, for example, as a dual-mass flywheel, which is secured in the radial inner area to a crankshaft flange 14 of a crankshaft 16 or some other drive shaft by a plurality of screw bolts 18. In its radial outer area, the flywheel 12 is fixedly connected with a thrust plate assembly 20. The thrust plate assembly 20 comprises a housing 22 and a pressure plate 24 which is axially displaceable in the housing 22 but is held so as to be substantially fixed with respect to rotation relative to the housing 22. The friction facings 26, 28 of a clutch disk 30 are located between the pressure plate 24 and the flywheel 12. This clutch disk 30 can be coupled in its radial inner hub area 32 with a driven shaft, for example, a transmission input shaft, so as to be fixed with respect to rotation relative to it. The pressure plate 24 is pretensioned basically in the direction of the flywheel 12 by an energy accumulator 34, for example, a diaphragm spring. In the present example, the clutch 10 is a push-type clutch.

As is shown in FIG. 2, coupling portions 36 and 38, respectively, are provided at the pressure plate 24 and at the housing 22 or, as the case may be, also at the flywheel 12. One of the coupling portions 36 and one of the coupling portions 38 are connected with one another by a coupling arrangement 40 extending approximately in circumferential direction. These coupling arrangements 40 are formed of flexible elements so that, in principle, an axial movement of the pressure plate 24 is possible for carrying out engagement and release processes. When the coupling portions 36, 38 are offset relative to one another in direction of the axis of rotation as is illustrated in FIG. 3 and the coupling arrangements 40 extend in the manner shown in FIG. 3, an application of force of the pressure plate 24 in circumferential direction with respect to the housing arrangement 22 in the direction indicated by the arrow P₁, which occurs, for example, in pull operation, results in a deflection of force due to lever ratios and leads to a reinforcement of the pressing force exerted on the friction facings 28, 26 by the pressing force 24, which reinforcement is directed as indicated by arrow P₂. In this type of clutch 10 with a self-reinforcing effect, it is possible to achieve pressing forces which are fundamentally higher than those that can be attained by conventional diaphragm springs while still allowing actuation. If an extremely high pressing force is not required, it is possible to provide the diaphragm spring and the energy accumulator 34 with lower pressing force capacity so that smaller release forces are also required.

It should be noted that only the basic construction of a friction clutch with self-reinforcing effect has been described thus far. Of course, a wide range of changes can be implemented in a clutch of this kind whether or not the principles of the present invention are applied, e.g., providing a wear compensating arrangement, a multi-mass flywheel as was already mentioned, a torsional vibration damper in the area of the clutch disk, and so on.

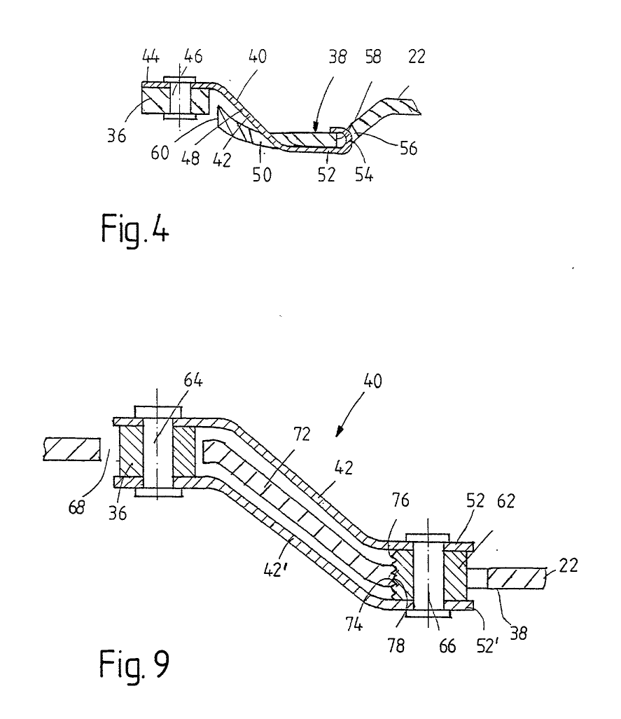

FIG. 4 shows a first construction, according to the invention, of the coupling of the pressure plate 24 with the housing 12 by means of a coupling arrangement 40 constructed as a leaf spring element 42. In a first coupling area 44, the leaf spring element 42 is secured by means of a rivet stud 46 to the coupling portion 36 of the pressure plate 24 which can be constructed, for example, as an arm portion which projects outward. As can be seen from FIG. 2, the leaf spring 42 extends approximately in circumferential direction toward the associated coupling portion 38 of the housing 22 proceeding from this coupling portion 36. In an inclined intermediate portion 48, the leaf spring 42 penetrates a corresponding opening 50 in the housing 12 in such a way that there is essentially no contact produced between this connecting portion 48 and the housing 22 irrespective of the state of relative rotation between the housing 22 and pressure plate 24. In a second coupling area 52, the leaf spring 42 has an end 54 which is bent in the shape of a hook. The leaf spring 42 engages by this hook-like end 54 in a recess or cutout 56 at the housing 22 with movement play in circumferential direction, that is, substantially in the direction of longitudinal extension of the leaf spring 42. A wall defining the cutout 56 in circumferential direction forms a first contact area 58. In pull operation, that is, in a state in which, due to the transmitted torque, the pressure plate is pretensioned and moved with respect to the housing 22 in such a way that coupling portion 36 is moved away from coupling portion 38 in FIG. 4, the leaf spring 42 contacts the first contact area with its hook-shaped end 54. Because of the movement play in the area of the opening 50, the self-reinforcing action described above can take place. However, when a clutch passes into pull operation proceeding from this state, i.e., when the engine braking action is initiated, for example, a force acts upon the pressure plate 24 with the result that the two coupling portions 36, 38 associated with a leaf spring 22 approach one another. Since the first contact area 58 for the second coupling area 52 is only effective in one direction, the hook-like end 54 of the second coupling area 52 moves away from the first contact area 58. However, during this movement, the coupling portion 36 of the pressure plate 24 comes into contact with a second contact area 60 of the housing 22, so that further rotation of the pressure plate 36 is impossible. In this state, the torque transmission between the pressure plate 24 and the housing 22 accordingly takes place via the second contact area, so that the leaf spring 42, or all leaf springs 42 are relieved from force. This eliminates the risk of compression loading or the deformation caused by it, nor is there any danger of damage to the leaf springs 42.

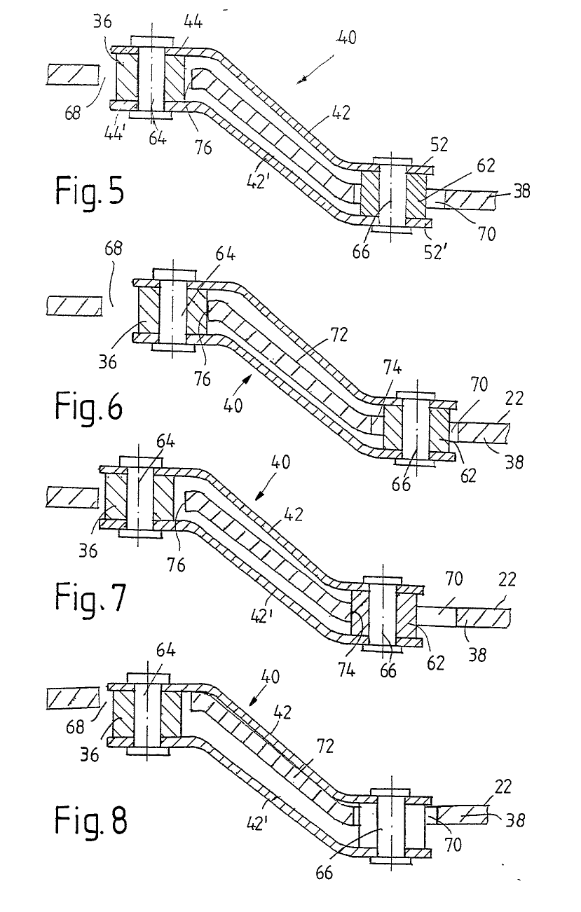

A modified embodiment form is shown in FIGS. 5 to 8. It will be seen that the coupling arrangement 40, or every coupling arrangement 40, has two leaf springs 42, 42′ which extend substantially parallel to one another at an axial distance from one another. In their first coupling areas 44, 44′ which extend substantially parallel to a plane extending essentially orthogonal to the axis of rotation A, the two coupling areas 44, 44′ are fixedly connected with one another by a rivet stud 64 with the intermediary of the associated coupling portion 36 of the pressure plate. In their two coupling areas 52, 52′, the leaf springs 42, 42′ are fixedly connected with one another by means of a rivet stud 66 with the intermediary of a spacer 62. It will be seen that the coupling portion 36 is arranged in a circumferential cutout 68 of a, e.g., radial or flange-shaped portion 72 of the housing 22. The spacer 62 is provided in a corresponding circumferential cutout 70 which is positioned so as to be offset axially and in circumferential direction with respect to the circumferential cutout 68. It will be seen that the circumferential extension of the cutout 68 is greater than that of cutout 70. A wall which defines the circumferential cutout 70 in circumferential direction and which lies closer to circumferential cutout 68 forms the first contact area 74. A wall which defines the circumferential cutout 68 and which lies closer to circumferential cutout 70 forms the second contact area 76. In load-free state, the coupling portion 36 and spacer 62 are held in such a way that there is essentially no contact with the respective contact areas 74 and 76. In push operation, shown in FIG. 6, that is, for example, when the engine braking effect is initiated or is active, the coupling portion 36 of the pressure plate 24 contacts the second contact area 76, but without the spacer 62 making any contact with the housing 22 such that a circumferential force is transmitted. Accordingly, a direct force-transmitting contact between the housing 22 and pressure plate 24 is ensured without the intermediary of the coupling arrangement 40 or coupling arrangements 40.

In the pull state shown in FIG. 7, in which the pressure plate 24 is displaced in circumferential direction in the opposite direction with respect to the housing 22, the coupling portion 36 is now held at a greater distance from the second contact area 76. However, the spacer 62 comes into contact with the first contact area 74 of the circumferential cutout 70. The torque transmission or circumferential force transmission between the housing 22 and the pressure plate is now effected via the two leaf springs 42, 42′ of a respective coupling arrangement 40, as a result of which the above-described stretching effect and self-reinforcing effect are initiated. This is possible in particular also because of the position of the two leaf springs 42, 42′ at an axial distance from one another. In order to prevent wear particularly in the area of the two contact areas 74, 76, hardened areas can be provided either at the housing 22 itself or in special insert parts. Accordingly, also in the construction variants shown in FIGS. 5 to 8, it is ensured that compression of the leaf springs is prevented, specifically in that these leaf springs do not take part at all in the transmission of force in the potentially critical push state.

FIG. 8 shows a state in which the pressure plate carrying the leaf springs 42, 42′ has been displaced axially with respect to the housing 22 in the engaged state, for example, as a result of the wear occurring at the friction linings of a friction clutch. This is made possible by providing two leaf springs 42, 42′ at an axial distance from on another, particularly in an arrangement such that the leaf spring 42 positioned on the side of the portion 72 remote of the flywheel is at an axial distance from this portion 72 in the new state.

FIG. 9 shows a modification of the embodiment form shown in FIGS. 5 to 8. It will be seen in this case that teeth 76 are provided on the side of the spacer 62 facing the first contact area 74. Corresponding teeth 78 can also be provided at the contact area 74. These two toothings 76, 78 engage in one another in the pull state, so that the spacer 62 and, therefore, also the two coupling areas 52, 52′ are held by an axial positive engagement with respect to the coupling portion 38 at the housing 22. This is particularly advantageous because, during the self-reinforcing action, not only is a circumferential force transmitted to the spacer 62 with respect to the housing 22, but an axial force component is also transmitted to the spacer 62 due to the axial offset of the respective coupling areas. The axially positive-locking engagement of the spacer 62 with respect to the housing 22 prevents an axial slip of the spacer 62 which would lead to a reduction in the self-reinforcing effect.

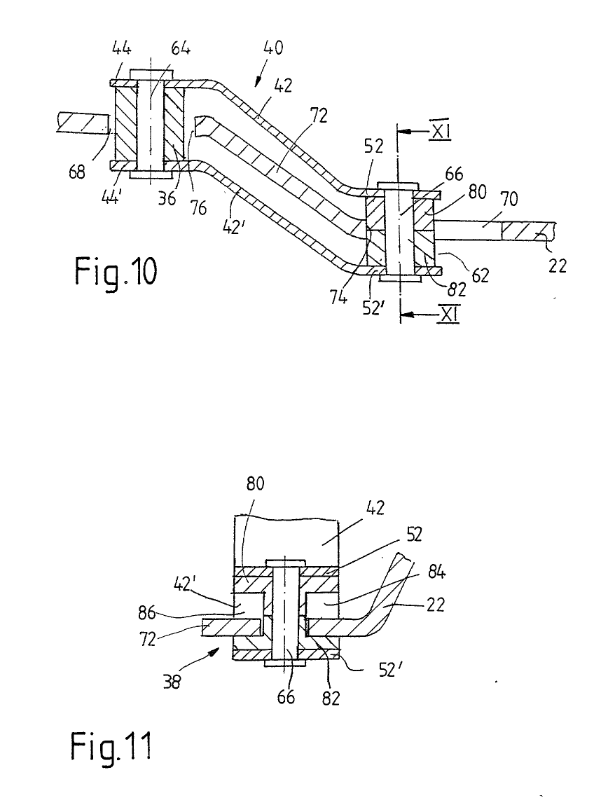

Another modification is shown in FIGS. 10 and 11. In this case, it will be seen that the spacer is formed of two parts having a substantially T-shaped cross section. These two parts 80, 82 form two pockets 84, 86 for receiving the material area of the housing 22 surrounding the circumferential cutout 70. The axial extension of the two pockets 84, 86 is smaller than the total axial extension of the spacer 62. This arrangement is especially advantageous when the toothing shown in FIG. 9 can not be provided. If the frictional force which acts between the spacer 62 and contact area 64 and acts against the axial displacement of the spacer 62 is not sufficient to prevent the above-mentioned displacement of the spacer 62 with respect to the housing 22 when force is transmitted in pull operation, then at least a limited axial lift of the spacer 62 and, therefore, of the two leaf springs in the area of their coupling areas 52, 52′ is ensured.

The preceding description has addressed embodiment forms of coupling arrangements and their cooperation with the pressure plate on one side and with the housing on the other side in which it is ensured that the pressure plate is coupled with the housing with respect to force by coupling arrangements only in one torque transmitting direction. This is the operating state in which there is tensile loading of the coupling arrangements and in which the desired self-reinforcing effect of the curved leaf springs can be used. In the push state, which is particularly critical with respect to compression, the leaf springs are exempted and can accordingly not be damaged or overloaded. Of course, it is possible to reverse the principle of the invention so that the coupling arrangements are free in circumferential direction in the area of their coupling with the pressure plate and are secured to the housing in the area of their coupling with the latter. However, the variant shown in the drawings is advantageous because of prevailing space relationships, particularly for introducing the circumferential cutouts extending in circumferential direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A thrust plate assembly for a friction clutch, said thrust plate assembly comprising
a housing,
a pressure plate, and
at least one leaf spring arrangement which holds said pressure plate so as to be axially movable with respect to said housing, said at least one leaf spring arrangement having a first coupling area which cooperates with said pressure plate for transmission of force and a second coupling area which cooperates with said housing for transmission of force, one of said first and second coupling areas cooperating with one of said housing and said pressure plate to transmit torque in only one direction.

2. A thrust plate assembly as in claim 1 wherein the other of said first and second coupling areas is secured to the other of the housing and the pressure plate for transmission of torque, said one of said housing and said pressure plate comprising a first contact area which supports said one of said first and second coupling areas for transmission of torque when the pressure plate rotates relative to the housing in a first relative rotation direction, and a second contact area which supports the other of said first and second coupling areas when the pressure plate rotates relative to the housing in a second relative rotation direction opposite to the first relative rotation direction without transmitting torque via said leaf spring arrangement.

3. A thrust plate assembly as in claim 2 wherein said one of said housing and said pressure plate comprises a cutout extending approximately circumferentially, said cutout being defined by a wall which forms said first contact area.

4. A thrust plate assembly as in claim 2 wherein said at least one leaf spring arrangement can positively engage said one of said coupling areas in a substantially axial direction.

5. A thrust plate assembly as in claim 4 wherein at least one of said first contact area and said one of said coupling areas comprises teeth.

6. A thrust plate assembly as in claim 2 wherein said second contact area is supported by the other of said coupling areas where said at least one leaf spring arrangement is secured to the other of said housing and pressure plate.

7. A thrust plate assembly as in claim 1 wherein said at least one leaf spring arrangement comprises two leaf spring elements which are axially spaced at least between the first coupling area and the second coupling area, and a spacer between said leaf spring elements, said one of said coupling areas being provided on said spacer.

8. A thrust plate assembly as in claim 1 wherein said first and second coupling aras are axially offset relative to each other.

9. A friction plate comprising a thrust plate assembly, said thrust plate assembly comprising
a housing,
a pressure plate, and
at least one leaf spring arrangement which holds said pressure plate so as to be axially movable with respect to said housing, said at least one leaf spring arrangement having a first coupling area which cooperates with said pressure plate for transmission of force and a second coupling area which cooperates with said housing for transmission of force, one of said first and second coupling areas cooperating with one of said housing and said pressure plate to transmit torque in only one direction.
